(19) United States
(12) Patent Application Publication
(10) Pub. No.: US 2026/0091648 A1
(43) Pub. Date: Apr. 2, 2026

(54) THERMAL ENERGY MANAGEMENT SYSTEM FOR HEATING IN ELECTRIFIED VEHICLE

(71) Applicants: Hyundai Motor Company, Seoul (KR); Kia Corporation, Seoul (KR)

(72) Inventors: Dong Su Ha, Hwaseong-si (KR); Han Nah Song, Hwaseong-si (KR); Beom Soo Kim, Hwaseong-si (KR); Jee Wook Huh, Hwaseong-si (KR); Yong Joo Lee, Hwaseong-si (KR)

(73) Assignees: Hyundai Motor Company, Seoul (KR); Kia Corporation, Seoul (KR)

(21) Appl. No.: 19/088,813

(22) Filed: Mar. 24, 2025

(30) Foreign Application Priority Data
Oct. 2, 2024 (KR) 10-2024-0133501

(51) Int. Cl. B60H 1/04; B60H 1/00; B60W 10/06; B60W 20/15

(52) U.S. Cl. CPC B60H 1/04; B60H 1/004; B60H 1/00778; B60H 1/00807; B60H 1/00885; B60W 10/06; B60W 20/15; B60W 2710/0666

(57) ABSTRACT

A thermal energy management system for heating in an electrified vehicle includes an input device used to enter a stay mode configured to allow a vehicle user to rest in the vehicle, use air conditioning, or use electrical energy of the vehicle in a parked state after arriving at a stay place, while the vehicle is driving, a control unit configured to enter a stay preparation mode while the vehicle is driving to the stay place, if an input to enter the stay mode is received through the input device, and an engine controlled by the controller to be turned on or off, wherein the control unit is provided to perform control to secure engine latent heat to be used during heating in the stay mode based on collected heating setting information and environmental information at the stay place, during the stay preparation mode until the vehicle arrives at the stay place.

### BACKGROUND OF THE PRESENT DISCLOSURE

### Field of the Present Disclosure

The present disclosure relates to a system configured for efficiently managing thermal energy for heating while driving that heats the interior of an electrified vehicle in a stay mode that enables use of electric vehicles without worrying about battery charging in the parked state of the vehicle and allows a vehicle user to rest or stay in the vehicle for a long time period.

### Description of Related Art

Recently, as the era of high oil prices continues, the demand for electrified vehicles is increasing, and the proportion of electrified vehicles among all vehicles is expected to gradually increase in the future.

Electrified vehicles may be vehicles that use an electric motor as a driving device to drive the vehicle, and vehicles that use a motor alone or a motor and an engine (i.e., internal combustion engine, ICE) together as driving devices are known.

Among electrified vehicles, vehicles that use a motor alone include battery electric vehicles (BEVs) that use batteries as a power source (electric power source), and fuel cell electric vehicles (FCEVs) that use fuel cells as a main power source.

Furthermore, vehicles which may use the combined power of a motor and an engine include general hybrid electric vehicles (HEVs) which may charge their batteries only with a self-power generation device, and plug-in hybrid electric vehicles (PHEVs) which may be connected to an external power supply to charge their batteries externally.

Among electrified vehicles, vehicles that can charge their batteries with an external power supply are battery electric vehicles and plug-in hybrid electric vehicles, and vehicles that charge their batteries using power generation devices that use fuel are hybrid electric vehicles (i.e., HEVs and PHEVs) and fuel cell electric vehicles.

In the case of hybrid electric vehicles, an engine that utilizes fuel and a motor (an HSG, a drive motor, or the like) that receives the rotational power of the engine and generates power are power generation devices, and in the case of fuel cell electric vehicles, a fuel cell that utilizes hydrogen as fuel gas is a power generation device.

Among electrified vehicles, battery electric vehicles (BEVs) are called pure electric vehicles, and hybrid electric vehicles (HEVs and PHEVs) that are driven with a motor and fuel cell electric vehicles (FCEVs) may also be called electric vehicles (xEVs) in a broad sense.

In the case of electric vehicles, it is true that there are limitations to market expansion due to charging infrastructure and vehicle prices, but since they may be driven with a motor alone, many users are satisfied with not only quietness and internal comfort but also driving performance.

As the COVID-19 period passes, the lifestyle patterns of vehicle users have changed significantly, the frequency of staying inside parked vehicles to rest and use various electrical devices, such as multimedia devices including an audio device, air conditioning devices, electrical products including game consoles and smartphones, and in-vehicle electrical outlets, is gradually increasing, and accordingly, various research and development to further improve internal livability of electrified vehicles is being conducted.

For example, a mode in which a vehicle is electrically connected to an external power supply and utilizes power supplied from the external power supply is known, and separately from the present mode, a mode in which a hybrid electric vehicle (HEV or PHEV) provided with a high-voltage battery idles a self-power generation device, i.e., an engine, to operate a motor or a generator using the rotational power of the engine to generate power for use of electrical devices, such as an air conditioner, is known.

Furthermore, in the case of fuel cell electric vehicles provided with a fuel cell, which is a power generation device that utilizes hydrogen gas as fuel, and a high-voltage battery, a vehicle user may stay in the fuel cell electric vehicle for a long time period while using electrical devices, such as an air conditioner.

However, in the case of hybrid electric vehicles provided with an engine among electrified vehicles, since idle charging in which a battery is charged by driving the engine must be performed to continuously use electric power, problems, such as noise, vibration, and exhaust, may be caused, and problems in terms of engine durability may be caused if the engine is left idling for a long time.

Furthermore, in the case of hybrid electric vehicles, when the vehicle interior needs to be heated while parked, an engine is driven to heat air with heat of the engine and the heated air is discharged to the vehicle interior for heating. However, since the engine is driven for heating even while parked and the heat of the engine is used for heating, non-driven engine loss occurs due to thermal energy consumption by the vehicle.

Here, non-driven engine loss refers to loss when the rotational power of the engine is not used as driving force to drive the vehicle but is used for other purposes. For example, non-driven engine loss may be loss when heat of the engine and energy generated by the engine is used for heating rather than driving the vehicle.

In the present way, when the vehicle is parked, since engine latent heat is insufficient, engine heat must be used for heating in the vehicle by driving the engine, and as described above, non-driven engine loss inevitably occurs.

To address these problems, management of thermal energy of the vehicle in advance while the vehicle is driving before the vehicle arrives at a parking space may be considered, and engine latent heat for heating may be controlled to maximize fuel efficiency until the vehicle arrives at the parking space.

However, there is no known technology for vehicle thermal energy management for heating while parked when the vehicle is moving to the parking space, i.e., thermal energy management and control technology for future vehicle stay, yet.

Furthermore, frequent engine on or off is required to control the engine latent heat while driving. However, frequent engine on or off may increase driver fatigue and deteriorate engine durability and vehicle marketability. Technology which may secure as much engine latent heat as possible for heating while parked while reducing frequent engine on or off while driving is needed.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a system configured for efficiently managing thermal energy for heating while driving that heats the interior of an electrified vehicle in a stay mode that enables use of electric vehicles without worrying about battery charging in a parked state of the vehicle and allows a vehicle user to rest or stay in the vehicle for a long time period.

Furthermore, it is another object of the present disclosure to provide a system that enables a driver to use a stay mode more comfortably by efficiently securing latent heat of an engine if the driver wants to execute the stay mode, and allows thermal energy management for heating in the stay mode to be performed by simple logic to have convenience in logic development.

Furthermore, it is yet another object of the present disclosure to provide a thermal energy management system that may minimize a sense of incongruity which may be felt by a driver due to frequent and sudden driving of an engine to secure thermal energy for heating in a stay mode in the parked state of a vehicle.

The objects of the present disclosure are not limited to the above-mentioned objects, and other objects not mentioned herein will be clearly understood by persons of ordinary skill in the art to which the present disclosure pertains (referred to as “those skilled in the art”) from the following description.

In one aspect, the present disclosure provides a thermal energy management system for heating in an electrified vehicle, including an input device for receiving an input to enter a stay mode configured to allow a vehicle user to rest in the vehicle, use air conditioning, or use electrical energy of the vehicle in a parked state after arriving at a stay place, while the vehicle is driving, a control unit configured to enter a stay preparation mode while the vehicle is driving to the stay place, if an input to enter the stay mode is received through the input device, and an engine controlled by the controller to be turned on or off, wherein the control unit is provided to perform control to secure engine latent heat to be used during heating in the stay mode based on collected heating setting information and environmental information at the stay place, during the stay preparation mode until the vehicle arrives at the stay place.

In an exemplary embodiment of the present disclosure, the vehicle may be a hybrid electric vehicle provided with an engine and a motor as driving devices for driving the vehicle.

In another exemplary embodiment of the present disclosure, the control unit may be provided to determine whether heating is needed after the vehicle arrives at the stay place based on a vehicle interior temperature detected by a sensor or a target heating temperature among the heating setting information, and an ambient air temperature of the stay place, which is the environmental information at the stay place, and perform control to secure the engine latent heat upon concluding that the heating is needed.

In yet another exemplary embodiment of the present disclosure, the control unit may be provided to determine a necessary heat load based on the heating setting information and the environmental information at the stay place, determine a control intensity based on the determined necessary heat load and the environmental information at the stay place, and perform the control to secure the engine latent heat depending on the determined control intensity.

In yet another exemplary embodiment of the present disclosure, the control unit may be provided to determine a required heat load corresponding to a target heating temperature and a target heating air volume, which are the heating setting information, and determine the necessary heat load corresponding to the determined required heat load and an ambient air temperature at the stay place, which is the environmental information at the stay place.

In still yet another exemplary embodiment of the present disclosure, the control unit may be provided to determine the control intensity further using a remaining distance to the stay place together with the necessary heat load and the environmental information at the stay place.

In a further exemplary embodiment of the present disclosure, the environmental information at the stay place used to determine the control intensity may be an ambient air temperature at the stay place.

In another further exemplary embodiment of the present disclosure, the vehicle may be a hybrid electric vehicle provided with an engine and a motor as driving devices for driving the vehicle, and the control to secure the engine latent heat may include electric vehicle (EV) line lowering control configured to lower an EV line configured to determine whether to turn on or off the engine by an amount corresponding to the control intensity, compared to during general driving when the stay preparation mode is not performed.

In yet another further exemplary embodiment of the present disclosure, the control to secure the engine latent heat may include engine torque increasing control configured to increase engine torque by an amount corresponding to the control intensity, compared to during general driving when the stay preparation mode is not performed.

In yet another further exemplary embodiment of the present disclosure, the control to secure the engine latent heat may include active air flap control configured to lower a closing setting temperature of an active air flap by an amount corresponding to the control intensity or raise an opening setting temperature of the active air flap by an amount corresponding to the control intensity, and the control unit may be provided to control the active air flap in a closed state during the stay mode after arriving at the stay place.

In still yet another further exemplary embodiment of the present disclosure, the control unit may be provided to further perform the control to secure the engine latent heat during the stay mode after arriving at the stay place, and the control to secure the engine latent heat during the stay mode may include control configured to lower a coolant temperature configured to turn on the engine as an engine-on condition to secure a heat source during heating by an amount corresponding to the control intensity, compared to during heating when the stay mode is not performed.

In a still further exemplary embodiment of the present disclosure, the control to secure the engine latent heat may include control of a valve of an integrated thermal management system so that a flow rate of a coolant supplied to a heater core and an oil warmer after passing through the engine is minimized.

In a yet still further exemplary embodiment of the present disclosure, the control unit may be provided to further perform the control to secure the engine latent heat during the stay mode after arriving at the stay place, and the control to secure the engine latent heat during the stay mode may include control of a valve of an integrated thermal management system so that all a coolant is circulated only through a circulation path between the engine and a heater core and the coolant does not flow to a radiator and an oil warmer.

In a further exemplary embodiment of the present disclosure, the control unit may be provided to further perform the control to secure the engine latent heat during the stay mode after arriving at the stay place, and the control to secure the engine latent heat during the stay mode may include control of an electric heating load of the vehicle.

In another further exemplary embodiment of the present disclosure, as the control to secure the engine latent heat during the stay mode, the control of the electric heating load of the vehicle may be control configured to operate the electric heating load at a maximum heating level or to turn on the electric heating load if the electric heating load is capable of only being turned on or off, during heating in a stopped state of the vehicle after arriving at the stay place.

In yet another further exemplary embodiment of the present disclosure, the control unit may be provided to start the control to secure the engine latent heat, if a remaining distance to the stay place is less than or equal to a set distance while the vehicle is driving toward the stay place.

Other aspects and exemplary embodiments of the present disclosure are discussed infra.

The above and other features of the present disclosure are discussed infra.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram showing the configuration of a hybrid system of an electrified vehicle to which the present disclosure is applied;

FIG. 2 is a block diagram showing the configuration of a thermal energy management system for heating in the electrified vehicle to which the present disclosure is applied, together with a control unit and operating elements of the vehicle;

FIG. 3 is a block diagram illustrating detailed components and inputs, outputs, and functions of a control unit that is configured to perform control for thermal energy management according to an exemplary embodiment of the present disclosure;

FIG. 4 is a flowchart showing a control process for thermal energy management according to an exemplary embodiment of the present disclosure;

FIG. 5 is a diagram illustrating first setting data which may be used to determine a required heat load in an exemplary embodiment of the present disclosure;

FIG. 6 is a diagram illustrating second setting data which may be used to determine a necessary heat load in an exemplary embodiment of the present disclosure;

FIG. 7 is a diagram illustrating examples of setting of a control intensity depending on the necessary heat load, a remaining distance, and an ambient air temperature in an exemplary embodiment of the present disclosure; and

FIG. 8, FIG. 9 and FIG. 10 are diagrams illustrating examples of a latent heat control state in each level of the control intensity in an exemplary embodiment of the present disclosure.

It should be understood that the appended drawings are not necessarily to scale, presenting a somewhat simplified representation of various exemplary features illustrative of the basic principles of the present disclosure. The specific design features of the present disclosure as included herein, including, for example, predetermined dimensions, orientations, locations, and shapes, will be determined in portion by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings. Specific structural or functional descriptions set forth in the exemplary embodiments of the present disclosure will be merely exemplarily provided to describe the exemplary embodiments depending on the concept of the present disclosure, and the exemplary embodiments depending on the concept of the present disclosure may be embodied in different forms. Furthermore, the present disclosure should not be construed as being limited to the exemplary embodiments set forth herein, and it will be understood that the present disclosure includes all modifications, equivalents, or substitutes included in the spirit and technical scope of the present disclosure.

In the following description of the embodiments, terms, such as “first” and “second,” and the like, are used only to describe various elements, and these elements should not be construed as being limited by these terms. These terms are used only to distinguish one element from other elements. For example, a first element described hereinafter may be termed a second element, and similarly, a second element described hereinafter may be termed a first element, without departing from the scope of the present disclosure.

When an element or layer is referred to as being “connected to” or “coupled to” another element or layer, it may be directly connected or coupled to the other element or layer, or intervening elements or layers may be present. In contrast, when an element or layer is referred to as being “directly connected to” or “directly coupled to” another element or layer, there may be no intervening elements or layers present. Other words used to describe relationships between elements should be interpreted in a like fashion, e.g., “between” versus “directly between,”“adjacent”versus “directly adjacent,”etc.

Wherever possible, the same reference numbers will be used throughout the following description to refer to the same or like parts. The terminology used herein is for describing various exemplary embodiments only and is not intended to be limiting. As used herein, singular forms may be intended to include plural forms as well, unless the context clearly indicates otherwise. The terms “comprises,” “comprising,” “including,” and “having” are inclusive and therefore specify the presence of stated features, integers, operations, operations, elements, components, and/or combinations thereof, but do not preclude the presence or addition of one or more other features, integers, operations, operations, elements, components, and/or combinations thereof.

The present disclosure provides a thermal energy management system for preparing a vehicle mode while moving to a parking space, which are applicable to an electrified vehicle driven in the vehicle mode (i.e., a stay mode) that enables use of electrical devices without worrying about battery charging in the parked state of the vehicle and allows a vehicle user to rest or stay in the vehicle for a long time period.

The present disclosure aims to provide a system configured for efficiently managing thermal energy for heating while an electrified vehicle is driving before arriving at a parking space to perform heating of the vehicle interior during the vehicle mode in the parked state of the vehicle.

The electrified vehicle to which the present disclosure is applied may be a vehicle provided with a high-voltage battery, a self-power generation device that generates power using fuel, and a charging device configured to charge the battery with the power generated by the power generation device.

The electrified vehicle to which the present disclosure is applied may be a hybrid electric vehicle having, as power generation devices, an engine which is driven by fuel to generate and provide rotational power, and a motor which may be operated as a generator by receiving the rotational power of the engine. Here, the motor may be a motor directly connected to the engine to be capable of transmitting power thereto perform engine startup, or a drive motor used as a driving device that drives the vehicle.

In the hybrid electric vehicle, the charging device mounted in the vehicle may include a power conversion device, such as an inverter or a converter for charging the high-voltage battery, which is an energy storage device of the vehicle.

In an exemplary embodiment of the present disclosure, as the vehicle mode that allows the vehicle user to rest or stay in the vehicle for a long time period, a mode in which the vehicle user can rest or stay in the vehicle while using electric devices with electric power generated by the self-power generation device using vehicle fuel or battery power charged by the self-power generation device (including battery power charged while driving) will be referred to as a “stay mode”.

The stay mode may be defined as a mode which is set and provided so that vehicle energy including electrical energy stored in the energy storage device (e.g., battery) of the vehicle is usable while the vehicle user stays in the vehicle in the parked state.

Furthermore, in an exemplary embodiment of the present disclosure, a mode in which control for thermal energy management according to an exemplary embodiment of the present disclosure is performed while the vehicle is driving to move to a place where the stay mode will be executed, i.e., a place where the vehicle user is stayable, such as a parking lot, a rest area, or a nap stop, will be referred to as a “stay preparation mode”.

The stay preparation mode is a vehicle mode while driving to prepare the stay mode in the parked state of the vehicle, and is a mode in which thermal energy management for heating is performed while the vehicle moves to a space where the stay mode will be used, assuming that the stay mode is performed after parking.

Accordingly, after going through the stay preparation mode in which thermal energy management is performed while driving according to an exemplary embodiment of the present disclosure, when the vehicle arrives at a stayable place (i.e., a stay place) input and selected by a driver, the stay mode may be executed.

In the electrified vehicle to which the present disclosure is applied, during the stay mode, an air conditioning device configured to generate a comfortable indoor environment while parked, an infotainment device which provides integrated functions of information and entertainment, various electric devices that are provided in or connected to the vehicle, and in-vehicle outlets may be used.

Furthermore, in the stay mode, engine startup may be minimized while stopped to reduce emotional dissatisfaction issues (such as engine idling noise when switching from the EV mode to the HEV mode), and it is possible to use the vehicle as a rest area where the driver rests in the vehicle after parking, after the driver has arrived at work earlier than the scheduled commuting time to avoid rush hour.

In the above-described stay mode, energy usage and consumption by the vehicle itself, other than the vehicle user's intended usage or purpose, is minimized to secure available energy which is usable by the vehicle user as much as possible and provide sufficient energy.

According to the stay mode, compared to a general internal combustion engine (ICE) vehicle that performs engine idling for a long time period, vehicle fuel efficiency may be improved, exhaust gas emissions may be reduced, and engine durability may be increased.

From the perspective of vehicle manufacturers, it is possible to alter consumers'perception of hybrid electric vehicles, which are still perceived as closer to general internal combustion engine (ICE) vehicles, as closer to pure electric vehicles, and accordingly, it is possible to more effectively and naturally respond to today's market changes that are occurring in the transition period to electric vehicles.

Conventionally, there were no known system and method for managing thermal energy of a vehicle while the vehicle is driving to a parking space, which is a destination, to use heating while parked.

If thermal energy by an engine is not sufficiently secured while the vehicle is driving before arriving at a stay place, i.e., a place where the stay mode of the vehicle will be executed in the parked state, thermal energy or electrical energy for heating must be newly secured in the parked state during the stay mode, and thus convenience of the stay mode may be halved. In addition, this may lower the frequency of driver's use of the stay mode, and may also be a factor in deteriorating vehicle marketability.

Therefore, in an exemplary embodiment of the present disclosure, if the driver wants to execute the stay mode, the vehicle enters the stay preparation mode to perform control for thermal energy management while driving, allowing the driver to use the stay mode in a more comfortable state after parking.

Furthermore, the present disclosure proposes a system which may provide convenience in control development through simplification of control logic in thermal energy management while driving for the stay mode and minimize a sense of incongruity felt by the driver when performing actual control.

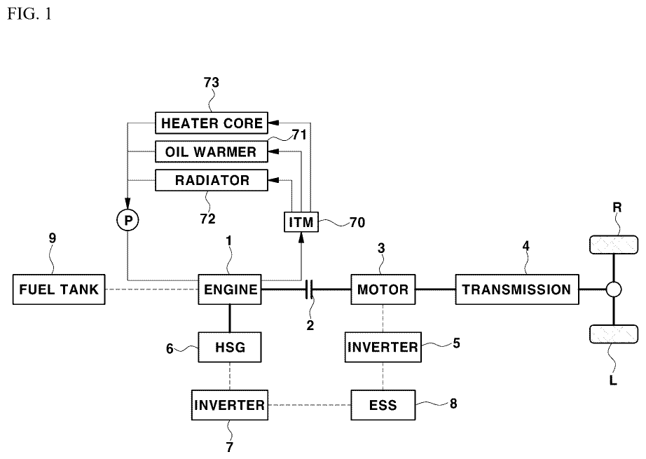

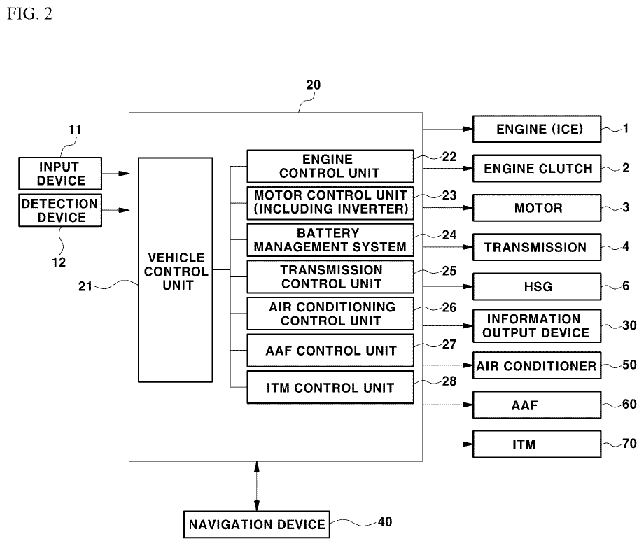

FIG. 1 is a block diagram showing the configuration of a hybrid system of an electrified vehicle to which the present disclosure is applied, and FIG. 2 is a block diagram showing the configuration of a thermal energy management system for heating in the electrified vehicle to which the present disclosure is applied, together with a control unit and operating elements of the vehicle.

FIG. 1 illustrates the configuration of the hybrid system including a powertrain apparatus of a parallel hybrid electric vehicle. As shown in the present figure, the hybrid system includes an engine 1 and a motor 3 as driving devices for vehicle driving, an engine clutch 2 located between the engine 1 and the motor 3, a transmission 4 connected to the output side of the motor 3 to be configured for transmitting power thereto, an inverter 5 configured to drive the motor 3, and an energy storage system (ESS) 8 connected to the motor 3 through the inverter 5 to be configured for being charged and discharged as a power source (electric power source) of the motor 3.

Here, the motor 3, i.e., a motor which is a driving device configured to drive the vehicle, is a drive motor mounted as a vehicle driving source in a general hybrid electric vehicle. Furthermore, the ESS 8 may include one or both of a battery and a capacitor.

In the following description, the battery is the ESS 8 which is connected to the self-power generation devices of the electrified vehicle to which the present disclosure is applied via inverters 5 and 7, which are charging devices, to be configured for being charged and discharged, and may be a high-voltage battery mounted in a general hybrid electric vehicle.

In FIG. 1, reference numeral “6” indicates a separator motor, i.e., a hybrid starter generator (HSG), which is connected to the engine 1 to be configured for transmitting power thereto and starts the engine 1 or generates power using rotational power transmitted from the engine 1.

The HSG 6 is operated as a motor or a generator, and is connected to the ESS 8 through the inverter 7 to be configured for being charged and discharged. Furthermore, the HSG 6 is connected to the engine 1 through a power transmission device, such as a belt and a pulley or a gear device, to be configured for transmitting power thereto at all times.

Although FIG. 1 illustrates the hybrid system including the HSG 6 connected to the engine 1 to be configured for transmitting power thereto at all times, the electrified vehicle to which the present disclosure is applied may be a hybrid electric vehicle in which, instead of the HSG 6 described above, a separate motor directly connected to the output side of the engine 1 to be configured for transmitting power thereto is mounted.

That is, in the hybrid system illustrated in FIG. 1, the HSG 6 may be removed, and a separate motor directly connected to the output side of the engine 1 to be configured for transmitting power thereto may be disposed between the engine 1 and the engine clutch 2. This motor is connected not only to the engine 1 but also to the engine clutch 2 to be configured for transmitting power thereto.

The motor may be used as a motor that starts the engine 1, and may also be used as a generator that assists engine power to drive the vehicle or generates electrical energy using the engine power. The motor on the output side of the engine 1 is also connected to the ESS 8 through an inverter to be configured for being charged and discharged.

The engine clutch 2 is hydraulically engaged (closed) to connect the engine 1 and the motor 3 so that power is transmittable therebetween or disengaged (opened) to separate the engine 1 and the motor 3. In hybrid electric vehicles, during idle charging, the rotational power of the engine 1 must be blocked so as not to be transmitted to the motor 3, and at the instant time, the engine clutch 2 is controlled to separate the engine 1 and the motor 3 to block power transmission.

In the configuration of FIG. 1, each inverter 5 or 7 converts the direct current of the ESS 8 into three-phase alternating current, and supplies the three-phase alternating current to the motor 3 or the HSG 6 to drive the motor 3 or the HSG 6. On the other hand, if the motor 3 and the HSG 6 are operated to generate power, each inverter 5 or 7 converts the alternating current generated by the motor 3 or the HSG 6 into direct current and supplies the direct current to the ESS 8.

Furthermore, the transmission 4 shifts the power of the motor 3 or the combined power of the engine 1 and the motor 3, and transmits the power to driving wheels L and R through a driveshaft. In FIG. 1, a fuel tank 9 stores fuel to be supplied to the engine 1, and the fuel may be a known engine fuel, such as gasoline, diesel, LPG, or the like.

The vehicle provided with the hybrid system of FIG. 1 may be driven in an electric vehicle (EV) mode, which is a pure electric vehicle mode in which only the power of the motor 3 is used, or in a hybrid electric vehicle (HEV) mode in which the power of the engine 1 and the power of the motor 3 are used in combination.

Furthermore, when braking the vehicle (when decelerating the vehicle due to brake pedal input) or when decelerating the vehicle by coasting due to inertia, a regenerative mode in which the kinetic energy of the vehicle is recovered as electrical energy through motor generation to charge the battery is performed. Such a regenerative mode function is essential to increase vehicle efficiency and improve fuel efficiency in the hybrid electric vehicle.

Furthermore, the hybrid electric vehicle is provided with a hybrid control unit (HCU) which is also referred to as a vehicle control unit (VCU) 21, which is an upper-level control unit configured to control the overall operation of the vehicle, and various other control units configured to control various devices of the vehicle.

For example, as shown in FIG. 2, an engine control unit (ECU) 22 that is configured to control the operation of the engine 1, a motor control unit (MCU) 23 that is configured to control the operation of the motor 3, a battery management system (BMS) 24 that collects battery status information, utilizes the information for battery charging and discharging control or provides the information to other control units, and is configured to perform control for managing the battery, i.e., the ESS 8, a transmission control unit (TCU) 25 that is configured to control the operation of the transmission 4, an air conditioning control unit 26 that is configured to control air conditioning, such as cooling and heating of the vehicle, an AAF control unit 27 that is configured to control the operation of an active air flap (AAF) 60, and an ITM control unit 28 that is configured to control the operation of a valve 70 of an integrated thermal management (ITM) system for engine coolant distribution control may be provided.

The hybrid control unit 21 and the respective control units 22, 23, 24, 25, 26, 27 and 28 perform cooperative control while exchanging information with each other through communication for vehicle power control and driving control, shift control, power generation control, battery charging and discharging control, air conditioning control, etc., and the upper-level control unit 21 transmits control commands to the lower-level control units 22, 23, 24, 25, 26, 27 and 28 while collecting various information from the lower-level control units 22, 23, 24, 25, 26, 27 and 28.

The control process for thermal energy management while driving according to an exemplary embodiment of the present disclosure may be performed by a plurality of control units that are configured to perform cooperative control as described above in an electrified vehicle, and for example, the control process may be performed by cooperative control of the hybrid control unit (HCU) 21, the engine control unit 22, the AAF control unit 27, the ITM control unit 28, etc.

Alternatively, the control process may be performed by one control unit including the integrated functions of the control units. Although a control subject has been described above as being divided into the plurality of control units, the control process for thermal energy management while driving according to an exemplary embodiment of the present disclosure may be performed by a single control element which may perform the functions of the plurality of control units in an integrated manner, instead of the plurality of control units described above.

In an exemplary embodiment of the present disclosure, the plurality of control units and the single control element may all be collectively referred as a control unit, and the control process according to an exemplary embodiment of the present disclosure, which will be described below, may be performed by the present control unit. In the following description, a control unit 20 collectively refers to the plurality of control units and the single control element.

Furthermore, a control system that is configured to perform thermal energy management according to an exemplary embodiment of the present disclosure includes an input device 11, a detection device 12, an information output device 30, and a navigation device 40, in addition to the control unit 20.

The input device 11 is used when the vehicle user (hereinafter including the driver) wants to input necessary information during thermal energy management while driving and a control process thereof according to an exemplary embodiment of the present disclosure. For example, the vehicle user such as the driver may request entry to the stay preparation mode or select entry to the stay preparation mode by operating the input device 11.

The input device 11 is electrically connected to the control unit 20. That is, the input device 11 is connected to the control unit 20 so that an electrical signal may be input through the input device 11, and any unit which is provided in the vehicle to be operatable for input and selection, such as a switch, a button, or a touchscreen, may be applied as the input device 11 in an exemplary embodiment of the present disclosure.

For example, the input device 11 may be an input device of an audio, video and navigation (AVN) system or audio, video, navigation and telematics (AVNT) system, and may be a touchscreen of the AVN system or the AVNT system.

Furthermore, the input device 11 may include a mobile device configured for installing and executing an application related to the stay mode. The mobile device must be able to be connected to the control unit 20 to be communicable therewith in the vehicle, and for the present purpose, an input/output communication interface for communication connection between mobile device and the control unit 20 is used.

Therefore, when an electrical signal depending on operation of the input device 11 is input to the control unit 20, the control unit 20 may recognize that the vehicle user requests or selects entry to the stay preparation mode, and may then perform entry to the stay preparation mode and start the stay preparation mode.

The detection device 12 is configured to detect information required in a process of performing control for thermal energy management while driving according to an exemplary embodiment of the present disclosure, and may include a plurality of sensors configured to obtain vehicle state information and environmental information.

The detection device 12 may include a water temperature sensor which is configured to detect an engine coolant temperature of the vehicle, an ambient air temperature sensor which is configured to detect an ambient air temperature, and an internal temperature sensor which is configured to detect a vehicle interior temperature, an intake air temperature sensor which is configured to detect the temperature of intake air drawn into the engine 1 (i.e., intake air temperature), and a vehicle speed sensor which is configured to detect a vehicle speed.

The information output device 30 outputs various information that needs to be provided to the vehicle user such as the driver during the control process for thermal energy management while driving according to an exemplary embodiment of the present disclosure, and the information output device 30 may include a display device that displays the information, and may further include a sound output device that outputs the information as sound.

Here, the display device may include a display device of a cluster or the navigation device (or AVN) 40. If a cluster is used as the display device, a cluster control unit, which is a control subject that performs communication and cooperative control with other control units, participates in the control process according to an exemplary embodiment of the present disclosure.

The navigation device 40 is electrically connected to the control unit 20 to enable input and output of signals, and performs a general road guidance function. That is, when the driver inputs and sets a destination in the navigation device 40, the navigation device 40 searches for and generates driving routes to the destination, and is configured to determine an expected driving distance, an expected driving time, and an expected arrival time for each driving route.

Thereafter, the navigation device 40 displays various navigation information including the driving route on a map selected by the driver, speed limits, a remaining driving distance to the destination, a remaining driving time, and the expected arrival time through the display device to provide the navigation information to the driver. Furthermore, the navigation device 40 transmits and inputs destination arrival information notifying that the vehicle has arrived at the destination to the control unit 20 when the vehicle arrives at the destination.

Furthermore, the navigation device 40 transmits information on stay places around the vehicle where the stay mode is configured for being executed and used, real-time vehicle position information obtained through a built-in Global Positioning System (GPS) receiver, road gradient information to the stay places, and real-time traffic information to the stay places received from outside the vehicle to the control unit 20.

The input device 11, the information output device 30, and the navigation device 40 are electrically connected to the control unit 20 to be configured for inputting electrical signals to the control unit 20 or receiving electrical signals from the control unit 20.

Although FIG. 2 illustrates the input device 11, the information output device 30, and the navigation device 40 as separate components, these devices 11, 30, and 40 may be replaced with an AVN or AVNT system which is already provided in the vehicle and is configured for performing the functions of the devices 11, 30, and 40, and in the instant case, the control unit of the AVN or AVNT system may participate in the control process of the present disclosure as a control subject that performs communication and cooperative control with other control units.

Hereinafter, a thermal energy management process according to an exemplary embodiment of the present disclosure will be described in detail.

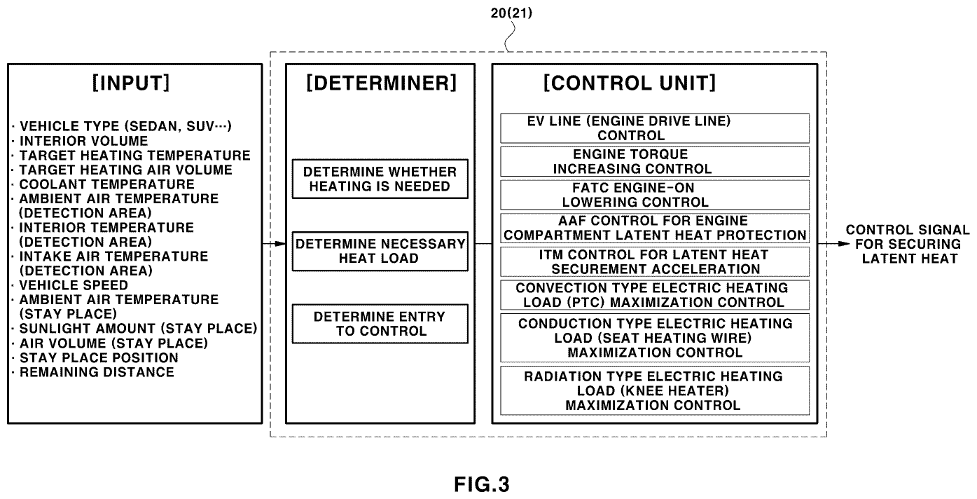

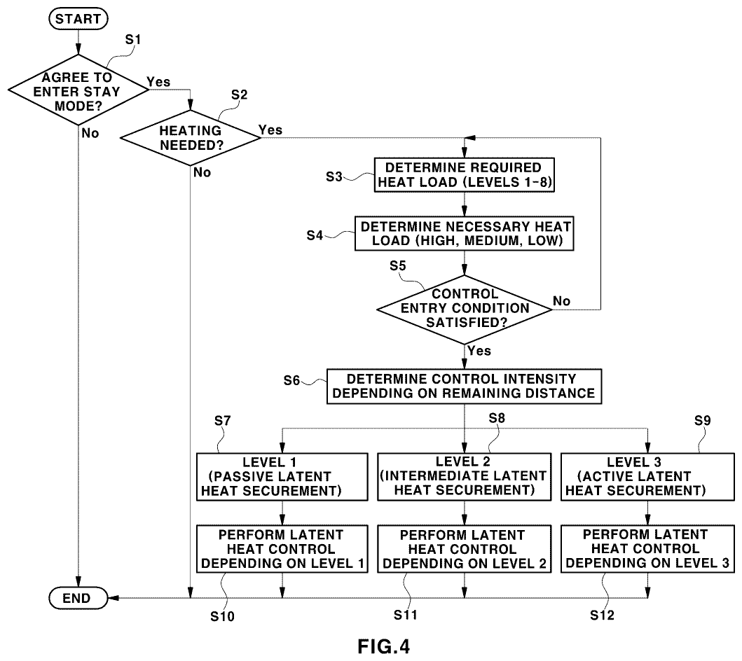

FIG. 3 is a block diagram illustrating detailed components and inputs, outputs, and functions of the control unit that performs control for thermal energy management according to an exemplary embodiment of the present disclosure, and FIG. 4 is a flowchart showing the control process for thermal energy management according to an exemplary embodiment of the present disclosure.

The control unit 20 illustrated in FIG. 3 may be the hybrid control unit 21 shown in FIG. 1, and may include a determiner that performs determination as to whether heating is needed, determination of a necessary heat load, and determination of entry to control, and a controller that outputs a control signal for securing latent heat depending on determination results of the determiner.

In an exemplary embodiment of the present disclosure, control for thermal energy management of the vehicle to be used for heating during the stay mode is performed by the control unit 20 in the stay preparation mode while the vehicle is driving before arriving at a stay place. In an exemplary embodiment of the present disclosure, in addition to the stay preparation mode, some control for thermal energy management may be performed in the stay mode.

To provide the stay mode, a place (hereinafter referred to as a “stay place”) where the vehicle user such as the driver may rest or stay in the vehicle while using electric devices in the vehicle in the parked state is required.

Considering this, in an exemplary embodiment of the present disclosure, the control unit 20 may be set to enter the stay preparation mode if the vehicle user inputs or selects a desired stay place through the input device 11 while the vehicle is driving.

As a method for the vehicle user such as the driver to determine entry to the stay preparation mode and start of thermal energy management control while driving, a method in which the driver selects and inputs a stay place at his or her own will may be used.

In an exemplary embodiment of the present disclosure, the stay preparation mode includes an active mode in which, if the driver wants to enter the stay preparation mode while driving, the driver makes a request for the vehicle to enter the stay preparation mode, and when the vehicle recommends stay places around the current position of the vehicle, the driver selects one of the recommended stay places, and thereby the vehicle enters the stay preparation mode.

Furthermore, the stay preparation mode further includes a passive mode in which the vehicle first recommends entry to the stay preparation mode, and if the driver agrees to enter the stay preparation mode through the input device 11 (S1), the vehicle recommends stay places around the current position of the vehicle, the driver selects one of the recommended stay places, and thereby the vehicle enters the stay preparation mode.

In an exemplary embodiment of the present disclosure, when the driver selects one of the active mode and the passive mode through the input device 11, the control unit 20 may allow entry to the stay preparation mode in the mode selected by the driver.

In the active mode, if the driver wants to enter the stay preparation mode, the driver may make a request for the control unit 20 of the vehicle to enter the stay preparation mode through the input device 11, and the control unit 20 may output information related to the closest stay place (stayable place) to the current position of the vehicle through the information output device 30 to inform the driver of the information.

Next, as the method for the driver to determine and select entry to the stay preparation mode and start of thermal energy management control while driving, a method in which the driver selects and inputs a stay place at his or her own will may be used.

That is, if the driver inputs the stay place at his or her own will through the input device 11, the control unit 20 enters the stay preparation mode, and starts control for thermal energy management while driving.

In the passive mode, if the vehicle recommends the driver to enter the stay preparation mode through the information output device 30 and recommends stay places, the driver may finally select one of the stay places through the input device 11.

At the present time, if the driver selects one of the stay places through the input device 11, the control unit 20 that has received the selected stay place enters the stay preparation mode, and starts control for thermal energy management while driving.

In the passive mode, the control unit 20 may be set to recommend entry to the stay preparation mode through the information output device 30, if a driver attention warning is required in conjunction with a driver attention warning system, for example, upon determining that the driver needs to rest and use the stay mode based on the driver state information.

For example, the control unit 20 may be configured to determine that the driver attention warning is required and thus determine that the driver needs to rest and use the stay mode, if a continuous driving time after the vehicle starts exceeds a set time or if the driver's driving state is a drowsy state.

When the control unit 20 recommends entry to the stay preparation mode through the information output device 30 as described above, the control unit 20 is configured to control operation of the information output device 30 to output a message recommending entry to the stay preparation mode and asking for an agreement to entry to the stay preparation mode.

The message recommending entry to the stay preparation mode is output for informing the driver that rest or sleep is needed and receiving an agreement to entry to the stay preparation mode, and at the instant time, the information output device 30 is controlled by the control unit 20 to display the message.

Thereafter, if the driver inputs an agreement to entry to the stay preparation mode through the input device 11 in response to the message, the control unit 20 outputs a message notifying of entry to the stay preparation mode and the stay mode through the information output device 30.

Thereafter, the control unit 20 displays information related to stayable places, i.e., stay places, such as parking lots, rest areas, or nap stops, through the information output device 30 to recommend the stay places, and then, the driver selects one of the displayed stay places through the input device 11.

If the driver does not select a stay place within a set time, the closest stay place to the current position of the vehicle may be automatically selected.

At the present time, if route guidance to the destination is being displayed through the navigation device 40, after the stay place has been selected as described above, the navigation device 40 outputs the position information of the stay place selected by the driver, sets the stay place as a stopover on the route to the destination, and then performs route guidance until moving to the stopover, i.e., the stay place.

Referring to FIG. 3, it may be seen that vehicle type and internal volume information and heating setting information, such as a target heating temperature and a target heating air volume, are input to the control unit 20 to perform control for thermal energy management according to an exemplary embodiment of the present disclosure.

Here, the vehicle type may indicate a sedan, a sports utility vehicle (SUV), or the like, and this indicates whether the corresponding vehicle is a sedan, an SUV, or another vehicle type, and is unique information of the vehicle. Furthermore, the vehicle interior volume information is also unique information of the vehicle.

The vehicle type and internal volume information may be information that the driver inputs through the input device 11 or that the control unit 20 receives from another control unit of the vehicle, but since the vehicle type and internal volume information is the unique information of the vehicle, they may be information which is set or stored in advance in the control unit 20.

Furthermore, after entering the stay preparation mode, the control unit 20 receives information on a set heating temperature and air volume at the stay place, i.e., information on the target heating temperature and the target heating air volume, and collects environmental information at the stay place through the AVN system of the vehicle.

The target heating temperature and the target heating air volume may be information set and input when the vehicle user such as the driver agrees to enter the stay preparation mode. The target heating temperature and the target heating air volume may be set so that the vehicle user inputs the information of the target heating temperature and the target heating air volume through the input device 11.

That is, if the vehicle user agrees to enter the stay preparation mode, the operation of the information output device 30 may be controlled by the control unit 20 to display a message guiding the vehicle user to set and input the target heating temperature and the target heating air volume during the stay mode, and then when the vehicle user inputs the target heating temperature and the target heating air volume through the input device 11, the input information may be stored in the control unit 20.

Furthermore, the control unit 20 wirelessly receives environmental information at the stay place through the AVN system from an external system outside the vehicle, and the environmental information may be weather information at the stay place.

The environmental information may include an ambient air temperature at the stay place. Furthermore, the environmental information may further include one or both of sunlight amount information and air volume information at the stay place.

Referring to FIG. 3, it may be seen that the engine coolant temperature, the ambient air temperature, the intake air temperature, and the vehicle speed which are detected by the water temperature sensor, the ambient air temperature, the intake air temperature sensor, and the vehicle speed sensor of the detection device 12, and the ambient air temperature and the sunlight amount and air volume information at the stay place, the position of the stay place, and the remaining distance to the stay place as the environmental information collected from the outside of the vehicle are input to the control unit 20.

The control unit 20 is configured to determine whether heating is needed at the stay place after entering the stay preparation mode (S2), and utilizes the collected environmental information at the stay place in a process of determining whether heating is needed.

The control unit 20 may be configured to determine whether heating is needed by a method of checking an environmental normal distribution that can cause a heating load based on the environmental information at the stay place. Alternatively, the control unit 20 may be configured to determine whether heating is needed based on the vehicle interior temperature (or the target heating temperature) which is a sensor detection value, and the ambient air temperature at the stay place, and may be configured to determine that heating is needed at the stay place if a difference between the internal temperature and the ambient air temperature exceeds a predetermined temperature.

Next, if the control unit 20 determines that heating is needed at the stay place after entering the stay preparation mode while the vehicle is moving and driving to the stay place, the control unit 20 starts control to secure engine latent heat to be used for heating in the stay mode, and in the instant case, the control unit 20 first is configured to determine a necessary heat load (S3 and S4).

At the present time, the necessary heat load may be determined based on the target heating temperature, the target heating air volume, and the ambient air temperature at the stay place, and may be determined by additionally considering the vehicle type, the internal volume, and the sunlight amount and air volume information at the stay place, selectively.

If the target heating air volume is set to a large value, the corresponding vehicle user is a user who requires a large heating load, i.e., actively wants heating, and if the ambient air temperature is low and the target heating temperature is set to a similarly low value, the corresponding vehicle user is a user who requires a small heating load.

In an exemplary embodiment of the present disclosure, the control unit 20 may be set to determine a required heat load depending on heating setting information set by the vehicle user such as the driver, i.e., the target heating air volume and the target heating temperature (S3), and then determine the necessary heat load from the required heat load and the ambient air temperature at the stay place (S4).

At the present time, the control unit 20 may use first setting data in which the required heat load is preset as a value depending on the target heating air volume and the target heating temperature, and second setting data in which the necessary heat load is preset as a value depending on the required heat load and the ambient air temperature.

The first setting data and the second setting data may be set based on data obtained through a preliminary test and evaluation process at the vehicle development stage, and may be used to determine a required heat load value and a necessary heat load value in a state in which the first setting data and the second setting data are input to and stored in advance in the control unit 20.

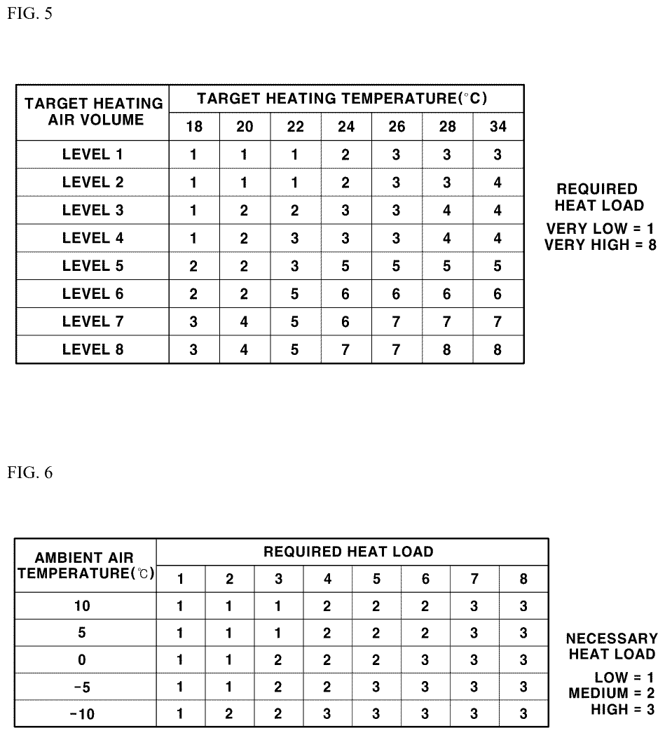

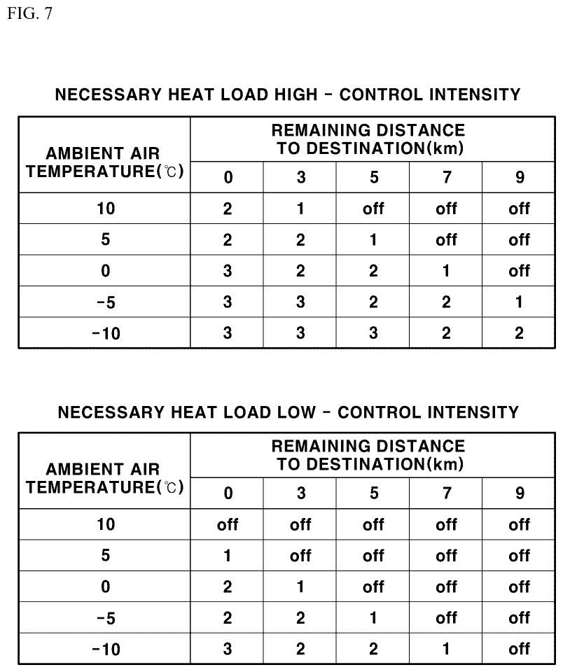

FIG. 5 is a diagram illustrating the first setting data which may be used to determine the required heat load in an exemplary embodiment of the present disclosure, and FIG. 6 is a diagram illustrating the second setting data which may be used to determine the necessary heat load in an exemplary embodiment of the present disclosure. As shown in these figures, setting data in a form of a table in which a required heat load value and a necessary heat load value are set depending on an input variable may be used.

In the first setting data of FIG. 5, required heat load values are set to levels 1 to 8. In the first setting data, a larger required heat load value means a larger heat load required by the vehicle user such as the driver. The target heating air volume increases as it goes from the lowest level, which is level 1, to the highest level, which is level 8.

Referring to FIG. 5, in the first setting data, the higher the target heating temperature, the greater value to which the required heat load is set, and this reflects that the higher the target heating temperature, the greater the heat load required by the vehicle user.

Furthermore, referring to FIG. 5, in the first setting data, the target heating air volume increases from a low level to a high level, and the required heat load is set to a larger value, and this reflects that the greater the target heating air volume, the greater the heat load required by the vehicle user.

Referring to FIG. 6, in the second setting data, the higher the required heat load value under the same ambient air temperature condition, the greater the necessary heat load value is set, and the higher the ambient air temperature under the same required heat load condition, the greater the necessary heat load value is set.

In the second setting data, necessary heat loads are set to values of 1, 2, and 3, and a larger necessary heat load value means a greater heat load when heating at the stay place.

In the case in which necessary heat loads are divided into “high”, “medium” and “low” depending on values thereof, if the necessary heat load value is 1, the necessary heat load is determined as “low” indicating the smallest necessary heat load, if the necessary heat load value is 2, the necessary heat load is determined as “medium” indicating the medium necessary heat load, and if the necessary heat load value is 3, the necessary heat load is determined as “high” indicating the greatest necessary heat load.

After the necessary heat load is determined in the present way, the control unit 20 is configured to determine whether a control entry condition for thermal energy management is satisfied by checking the remaining distance to the current stay place while the vehicle is driving (S5).

Here, the control unit 20 is configured to determine entry to the control for thermal energy management and starts the control for thermal energy management, if the remaining distance to the stay place (hereinafter referred to as the “remaining distance”) is less than or equal to a set distance (e.g., 10 km).

In the control process for thermal energy management of the present disclosure, a process of controlling engine latent heat, i.e., a latent heat control process to secure the engine latent heat which may satisfy the necessary heat load from a point in time of entering the control for thermal energy management until the vehicle arrives at the stay place, is performed.

When latent heat control starts, the control unit 20 is configured to determine a control intensity based on the necessary heat load and the remaining distance before the vehicle arrives at the stay place, and the ambient air temperature at the stay place (S6-S9), and is configured to perform latent heat control depending on the determined control intensity (S10-S12). For the present purpose, a plurality of levels of the control intensity, such as level 0 (off), level 1, level 2, level 3, etc. is set in the control unit 20.

In more detail, third setting data in which the levels of the control intensity set depending on the necessary heat load, the remaining distance, and the ambient air temperature are input to and stored in advance in the control unit 20. When performing latent heat control in the instant state, the control unit 20 selects a level of the control intensity corresponding to the current necessary heat load, remaining distance, and ambient air temperature among the plurality of set levels of the control intensity from the third setting data.

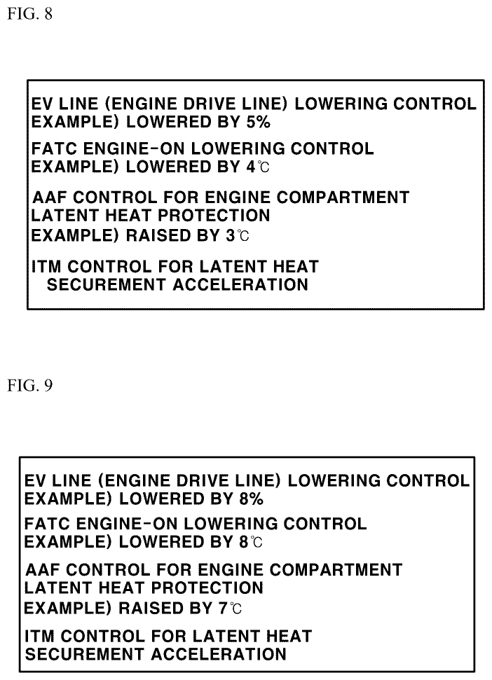

FIG. 7 is a diagram illustrating examples of setting of the control intensity depending on the necessary heat load, the remaining distance, and the ambient air temperature in an exemplary embodiment of the present disclosure. FIG. 7 illustrates a case in which the necessary heat load is “high” and a case in which the necessary heat load is “low”, and a case in which the necessary heat load is “medium” is omitted.

In the third setting data, level 0 (i.e., the off level) among the levels of the control intensity is a level where latent heat control is not performed, and as the control intensity progresses from level 1, which is the lowest level, to level 3, which is the highest level, latent heat control with an intensity which may secure a greater amount of engine latent heat is performed.

In the third setting data, the remaining distance to the stay place, i.e., the remaining distance, is set to a value less than or equal to the set distance (e.g., 10 km). Furthermore, referring to FIG. 7, in the third setting data, the control intensity is set to a lower level as the remaining distance increases under the same ambient air temperature condition.

Accordingly, when latent heat control is started after the remaining distance falls within the set distance, the control intensity is determined and adjusted to a higher level as the vehicle gets closer to the stay place based on the third setting data while the vehicle is driving.

Furthermore, referring to FIG. 7, in the third setting data, the control intensity is set to a higher level as the ambient air temperature is lower under the remaining distance condition. Furthermore, referring to FIG. 7, under the same remaining distance condition and the same ambient air temperature condition, the control intensity if the necessary heat load is “high” is set to a higher level than the control intensity if the necessary heat load is “low”.

At the present time, the control intensity if the necessary heat load is “high” and the control intensity if the necessary heat load is “low” may be the same level under some remaining distance conditions or some ambient air temperature conditions among the above-described same conditions. For example, in the case of FIG. 7, if the ambient air temperature is −10° C. and the remaining distance is 0 km, the control intensity is the same, i.e., level 3, and if the ambient air temperature is 5° C. and the remaining distance is 7 km, the control intensity is the same, i.e., the off level.

Although illustration of the case in which the necessary heat load is “medium” is omitted, the control intensity may be set to a level corresponding to the median of the level of the control intensity in the case in which the necessary heat load is “high” and the level of the control intensity in the case in which the necessary heat load is “low” under the same conditions, and the control intensity in the case in which the necessary heat load is “medium” may be set to the same level of the control intensity in the case in which the necessary heat load is “high” or the control intensity in the case in which the necessary heat load is “low” under some remaining distance conditions or some ambient air temperature conditions.

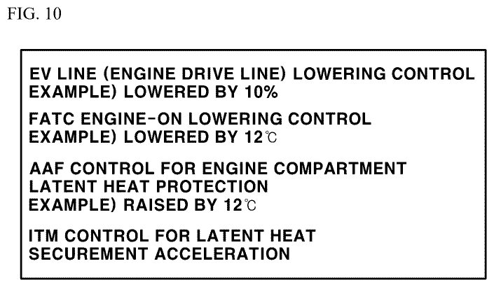

FIG. 8, FIG. 9 and FIG. 10 are diagrams illustrating examples of a latent heat control state in each level of the control intensity in an exemplary embodiment of the present disclosure.

Level 1 of the control intensity shown in FIG. 8 is a level in which control for passive latent heat securement is performed, level 2 of the control intensity shown in FIG. 9 is a level in which control of intermediate latent heat securement is performed, and level 3 of the control intensity shown in FIG. 10 is a level in which control of active latent heat securement is performed.

In an exemplary embodiment of the present disclosure, latent heat control may include, as illustrated in FIG. 3, electric vehicle (EV) line control, an engine torque increasing control, engine-on lowering control for air conditioning (FATC), active air flap (AAF) control for engine compartment latent heat protection, ITM control for latent heat securement acceleration, and at least one of convection type electric heating load maximization control, conduction type electric heating load maximization control, and radiation type electric heating load maximization control as control of an electric heating load.

Some of the above controls may be performed during the stay preparation mode while the vehicle is driving, some may be performed during the stay mode after arriving at the stay place, and some may be performed during both the stay preparation mode and the stay mode.

Explaining the latent heat control in detail, the EV line is a line that determines whether to turn the engine on or off in a hybrid electric vehicle, and is setting data which is input to and stored in advance in the control unit 20 and is then used to determine whether to turn the engine on or off depending on the vehicle driving state.

The EV line in a hybrid electric vehicle defines the transition conditions from the EV mode (engine off) to the HEV mode (engine on), and a boundary line in a form of a graph where the EV mode and the HEV mode are mutually switched for various variables may be defined as the EV line.

The EV line may include an engine-on line (engine drive line) in which the engine is turned on and an engine-off line in which the engine is turned off depending on the vehicle driving state, and may be generally defined in a map where driver's required power is set depending on a vehicle speed and a battery state of charge (SoC).

It is known that, in a general hybrid electric vehicle, the EV line is lowered (a point in time when the engine 1 is turned on is brought forward) to achieve SoC defense, and even in a low vehicle speed and low acceleration position sensor (APS) value situation, the engine 1 is started and then engine lock-up in which the motor (drive motor) 3 is operated as a generator with engine torque by engaging the engine clutch 2 is induced.

Conditions in which it is easy to switch from the EV mode to the HEV mode may include various variables, and lowering the EV line means adjusting the EV line, the engine-on line, so that the engine 1 is turned on under lower variable conditions to switch to the HEV mode.

For example, the EV line may be a boundary line connecting map values (required power values) for each vehicle speed and battery SoC where mutual transition between the EV mode and the HEV mode occurs in a power map where the required power values are mapped depending on the vehicle speed and the battery SoC.

Here, lowering the EV line may mean lowering conditions for switching from the EV mode to the HEV mode, i.e., lowering the required power values (values of the engine-on line) for each vehicle speed and SoC where the engine starts from the engine-off state, compared to general driving in which the stay preparation mode is not performed.

Accordingly, by lowering the EV line in a hybrid electric vehicle, SoC defense to maintain the battery SoC higher than the idle charging SoC while the engine is repeatedly turned on or off may be achieved.

In an exemplary embodiment of the present disclosure, after entering the stay preparation mode, the control unit 20 may be configured for controlling and change the EV line depending on the above-determined level of the control intensity to secure engine latent heat while the vehicle is diving, and may lower the EV line for determining whether to turn on the engine 1 from the engine-off state, i.e., the engine-on line, to increase an engine driving time and driving amount and secure more engine latent heat under the same vehicle driving conditions (vehicle speed, SOC value, required power, etc.).

For the present purpose, in an exemplary embodiment of the present disclosure, the lowering rate (%) of the EV line may be preset for each level of the control intensity. Here, a larger lowering rate may be set for a higher level of the control intensity.

For example, in the case of level 1 with the smallest control intensity, the lowering rate may be set to 5% (see FIG. 8), in the case of level 2 with a medium control intensity, the lowering rate may be set to 8% (see FIG. 9), and in the case of level 3 with the greatest control intensity, the lowering rate may be set to 10% (see FIG. 10).

That is, in the case of level 1, which requires passive latent heat securement, the map value of the EV line is lowered by 5% of the previous map value, in the case of level 2, the map value of the EV line is lowered by 8% of the previous map value, and in the case of level 3, which requires active latent heat securement, the map value of the EV line is lowered by 10% of the previous map value.

Next, engine torque increasing control is control that determines an engine torque from vehicle driving information while the vehicle is driving after entering the stay preparation mode, and in the instant case, determines the engine torque value as a larger value than in general driving (when the stay preparation mode and the stay mode are turned off) under the same vehicle driving conditions.

As described above, even under the same driving conditions, if the engine torque is increased, more engine latent heat may be secured. of course, even in the case of EV line lowering control and engine torque increasing control, the required torque for vehicle driving may be satisfied by the sum of engine torque and motor torque.

In an exemplary embodiment of the present disclosure, for engine torque increasing control, the control unit 20 may set a torque increasing rate (%) for each of the above-determined levels of the control intensity, similar to EV line lowering control.

Here, a larger increasing rate may be set for a level with a higher control intensity. The increasing rate may be set to a larger value in level 2 than in level 1 of the control intensity, and the increasing rate may be set to a larger value in level 3 than in level 2.

Accordingly, while the vehicle is driving after entering the stay preparation mode, if the control intensity is level 1, which requires passive latent heat securement, the control unit 20 is configured to determine engine torque as a value that increases engine torque (a command value), determined based on the vehicle driving information by a general method, by the smallest increasing rate, and is configured to control the engine with the increased engine torque.

Furthermore, the control unit 20 increases the engine torque by a medium increasing rate in the case of level 2, and increases the engine torque by the greatest increasing rate in the case of level 3.

Next, the engine-on lowering control for air conditioning (full automatic temperature control, FATC) is control in which the control unit 20 lowers an engine-on condition to secure a heat source during heating. The present engine-on lowering control for air conditioning may be performed in the state in which the stay mode is started after the vehicle has arrived at the stay place.

In the engine-on lowering control for air conditioning, a coolant temperature condition to turn on the engine 1 during heating is lowered compared to during heating not in the stay mode, as a non-driven engine operation condition and the engine-on condition to secure the heat source during heating. At the instant time, since the present case corresponds to non-driven engine operation in the stay mode, the engine clutch 2 is controlled to be disengaged by the control unit 20.

In an exemplary embodiment of the present disclosure, the control unit 20 may lower the coolant temperature condition depending on the control intensity determined during the stay preparation mode, store the lowered coolant temperature condition, and allow the lowered coolant temperature condition to be applied in the stay mode.

When the vehicle to which the present disclosure is applied arrives at the stay place and then performs heating, the engine coolant temperature is lowered. Thereafter, non-driven engine operation is performed by turning on the engine 1 under a specific coolant temperature condition, for example a condition “47° C. @ambient air temperature −7° C.”, i.e., under a condition where a coolant temperature is 47° C. at an ambient air temperature of −7° C., securing the heat source required for heating.

In an exemplary embodiment of the present disclosure, a change to lower the coolant temperature depending on the ambient air temperature may be performed in the stay preparation mode. Here, the coolant temperature depending on the ambient air temperature which is set in the control unit 20 may be lowered by a temperature set depending on the control intensity so that the engine 1 is turned on for non-driven engine operation during heating. Thereafter, when heating in the stay mode, the changed condition is applied that the non-driven engine operation to secure the heat source may be performed.

In an exemplary embodiment of the present disclosure, the higher the level of the control intensity, the more the coolant temperature at which the engine 1 is turned on may be lowered. That is, a temperature drop value in level 2 is set to a larger value than a temperature drop value in level 1 of the control intensity, and a temperature drop value in level 3 is set to a larger value than the temperature drop value in level 2 of the control intensity in the control unit 20.

Referring to examples of FIG. 8, FIG. 9 and FIG. 10, the temperature drop value is set to 4° C. in level 1, the temperature drop value is set to 8° C. in level 2, and the temperature drop value is set to 12° C. in level 3, and accordingly, the coolant temperature depending on the ambient air temperature at which the engine 1 is turned on during heating in the stay mode is lowered by 4° C. in level 1, by 8° C. in level 2, and by 12° C. in level 3.

Next, the control unit 20 is configured to perform the active air flap (AAF) control for engine compartment latent heat protection after entering the stay preparation mode. That is, the active air flap (AAF) control may be performed to prevent heat from being transferred to the outside from the engine compartment that has secured engine latent heat.

The active air flap (AAF) control may be performed by cooperative control of the vehicle control unit 21 and the AAF control unit 27, and in a vehicle provided with a general active air flap, the opening and closing operation of the AAF 60 is controlled depending on the engine coolant temperature, the intake air temperature, the vehicle speed, a driving load, etc.

For example, an opening setting temperature is determined depending on the current intake air temperature, and the determined opening setting temperature is corrected depending on conditions, such as the real-time vehicle speed and the driving load. Furthermore, the corrected opening setting temperature is compared with the current coolant temperature, and if the coolant temperature exceeds the corrected opening setting temperature, the AAF 60 is controlled to be in the open state.

Furthermore, a closing setting temperature is determined depending on the current intake air temperature, and the determined closing setting temperature is corrected depending on conditions, such as the real-time vehicle speed and the driving load. Furthermore, the corrected closing setting temperature is compared with the current coolant temperature, and if the coolant temperature is lower than the corrected closing setting temperature, the AAF 60 is controlled to be in the closed state.

In an exemplary embodiment of the present disclosure, during the stay preparation mode in which the vehicle is driving to the stay place, the closing setting temperature and the opening setting temperature may be additionally corrected depending on each level of the control intensity, and the opening and closing operation of the AAF 60 may be controlled by the additionally corrected closing setting temperature or opening setting temperature.

For example, in the stay preparation mode, to protect the engine latent heat, additional correction to lower the closing setting temperature by a correction amount for each level of the control intensity may be performed or additional correction to raise the opening setting temperature by a correction amount for each level of the control intensity may be performed compared to general driving, and at the instant time, the higher the level of the control intensity, the more the closing setting temperature may be lowered or the more the opening setting temperature may be raised.

That is, the correction amount to lower the closing setting temperature in level 2 may be set to a larger value than the correction amount to lower the closing setting temperature in level 1 of the control intensity, and the correction amount to lower the closing setting temperature in level 3 may be set to a larger value than the correction amount to lower the closing setting temperature in level 2 of the control intensity.

Likewise, the correction amount to raise the opening setting temperature in level 2 may be set to a larger value than the correction amount to raise the closing setting temperature in level 1 of the control intensity, and the correction amount to raise the opening setting temperature in level 3 may be set to a larger value than the correction amount to raise the opening setting temperature in level 2 of the control intensity.

Referring to FIG. 8, FIG. 9 and FIG. 10, the opening setting temperature is raised by 3° C. in level 1 of the control intensity, the opening setting temperature is raised by 7° C. in level 2 of the control intensity, and the opening setting temperature is raised by 12° C. in level 3 of the control intensity.

Furthermore, in an exemplary embodiment of the present disclosure, during the stay mode after the vehicle has arrived at the stay place, the AAF 60 may be controlled to maintain a closed state.

Next, control of the valve 70 of the integrated thermal management (ITM) system that is configured to perform engine coolant distribution control to accelerate heat securement during the stay preparation mode and the stay mode is performed.

In a vehicle provided with a general integrated thermal management system, if the vehicle is in a general driving mode other than the stay preparation mode and the stay mode, i.e., while the vehicle is driving in the general driving mode in the OFF state of the stay preparation mode and the stay mode, the valve 70 of the ITM system limits the flow rate of the coolant supplied to a heater core 73 for heating to a set minimum flow rate.

Furthermore, in the general driving mode, the valve 70 of the ITM system is configured to control the flow rate of the coolant supplied to an oil warmer 71 configured to adjust the temperature of an automatic transmission fluid (ATF) so that the flow rate reaches the maximum flow rate (increasing oil temperature control (cooling performance), and at the same time, is configured to control the flow rate of the coolant supplied to a radiator 72 to maintain a target coolant temperature.

On the other hand, during the stay preparation mode in which the vehicle is moving to the stay place, the valve 70 of the ITM system may limit the flow rate of the coolant supplied from the engine 1 to the heater core 73 for heating to a set minimum flow rate.

At the same time, the valve 70 of the ITM system may be controlled by the control unit 20 so that the flow rate of the coolant flowing to the oil warmer 71 after passing through the engine 1 is also the minimum amount which may maintain an oil temperature within a set range.

In the case of the engine 1, the coolant is circulated as in general driving to prevent the engine 1 from overheating, and at the instant time, the coolant is not supplied and circulated to the radiator 72, and the coolant may be supplied and circulated to the radiator 72 only when needed to maintain the target coolant temperature set higher than in general driving.

Furthermore, during the stay mode after the vehicle has arrived at the stay place, the valve 70 of the ITM system is controlled so that all the coolant is circulated only through a circulation path between the engine 1 and the heater core 73 and the coolant does not flow to the oil warmer 71 and the radiator 72.

Furthermore, in an exemplary embodiment of the present disclosure, control of a convection type electric heating load, a conduction type electric heating load, and a radiation type electric heating load, which are electric heating loads operated to perform heating in the vehicle during the stay mode, may be performed by the control unit 20.

The convection type electric heating load may be a general electric heater (PTC heater) used for heating in the vehicle, the conduction type electric heating load may be a general seat heating wire, and the radiation type electric heating load may be a general knee heater.

In an exemplary embodiment of the present disclosure, to secure engine latent heat during the stay mode, when heating in the vehicle in the stopped state after arriving at the stay place, each of the above electric heating loads may be controlled in the maximum heating state and level. If the electric heating load is a heating load which may only be turned on or off (e.g., a knee heater), the electric heating load may be turned on to perform heating.

In the present way, by controlling the electric heating loads in the maximum heating state and level when stopped, the engine heat may be maintained as much as possible, and ultimately, the efficiency of the system may be increased.

As is apparent from the above description, according to a thermal energy management system for heating in an electrified vehicle according to an exemplary embodiment of the present disclosure, to perform heating in the electrified vehicle in a stay mode, vehicle thermal energy including engine latent heat may be managed more efficiently in a stay preparation mode in which the vehicle is driving, and a driver may use the stay mode more comfortably by efficiently securing the engine latent heat.

Furthermore, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), Silicon Disk Drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like. Furthermore, the non-transitory computer-readable recording medium may be distributed over computer systems connected through a network, and computer-readable program code may be stored and executed in a distributive manner.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well-known to a person including ordinary knowledge in the art.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, multiple operations may be merged, or any operation may be divided, and a specific operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A thermal energy management system for heating in an electrified vehicle, the system comprising:
an input device for receiving an input to enter a stay mode configured to allow a vehicle user to rest in the vehicle, use air conditioning, or use electrical energy of the vehicle in a parked state after arriving at a stay place, while the vehicle is driving;
a control unit operatively connected to the input device and configured to enter a stay preparation mode while the vehicle is driving to the stay place, in response that the input to enter the stay mode is received through the input device; and
an engine controlled by the controller to be turned on or off,
wherein the control unit is configured to perform control to secure engine latent heat to be used during heating in the stay mode based on collected heating setting information and environmental information at the stay place, during the stay preparation mode until the vehicle arrives at the stay place.

2. The thermal energy management system of claim 1, wherein the vehicle is a hybrid electric vehicle provided with the engine and a motor as driving devices for driving the vehicle.

3. The thermal energy management system of claim 1, wherein the control unit is further configured to:
determine whether the heating is needed after the vehicle arrives at the stay place based on a vehicle interior temperature detected by a sensor or a target heating temperature among the heating setting information, and an ambient air temperature of the stay place, which is the environmental information at the stay place; and
perform control to secure the engine latent heat upon concluding that the heating is needed.

4. The thermal energy management system of claim 1, wherein the control unit is further configured to:
determine a necessary heat load based on the heating setting information and the environmental information at the stay place;
determine a control intensity based on the determined necessary heat load and the environmental information at the stay place; and
perform the control to secure the engine latent heat depending on the determined control intensity.

5. The thermal energy management system of claim 4, wherein the control unit is further configured to:
determine a required heat load corresponding to a target heating temperature and a target heating air volume, which are the heating setting information; and
determine the necessary heat load corresponding to the determined required heat load and an ambient air temperature at the stay place, which is the environmental information at the stay place.

6. The thermal energy management system of claim 4, wherein the control unit is further configured to determine the control intensity further using a remaining distance to the stay place together with the necessary heat load and the environmental information at the stay place.

7. The thermal energy management system of claim 6, wherein the environmental information at the stay place used to determine the control intensity is an ambient air temperature at the stay place.

8. The thermal energy management system of claim 4,
wherein the vehicle is a hybrid electric vehicle provided with the engine and a motor as driving devices for driving the vehicle, and
wherein the control to secure the engine latent heat includes electric vehicle (EV) line lowering control configured to lower an EV line configured to determine whether to turn on or off the engine by an amount corresponding to the control intensity, compared to during general driving when the stay preparation mode is not performed.

9. The thermal energy management system of claim 4, wherein the control to secure the engine latent heat includes engine torque increasing control configured to increase engine torque by an amount corresponding to the control intensity, compared to during general driving when the stay preparation mode is not performed.

10. The thermal energy management system of claim 4,
wherein the control to secure the engine latent heat includes active air flap control configured to lower a closing setting temperature of an active air flap by an amount corresponding to the control intensity or raise an opening setting temperature of the active air flap by an amount corresponding to the control intensity, and
wherein the control unit is further configured to control the active air flap in a closed state during the stay mode after arriving at the stay place.

11. The thermal energy management system of claim 4,
wherein the control unit is further configured to further perform the control to secure the engine latent heat during the stay mode after arriving at the stay place, and
wherein the control to secure the engine latent heat during the stay mode includes control configured to lower a coolant temperature configured to turn on the engine as an engine-on condition to secure a heat source during heating by an amount corresponding to the control intensity, compared to during heating when the stay mode is not performed.

12. The thermal energy management system of claim 1,
wherein the control to secure the engine latent heat includes control of a valve of an integrated thermal management system so that a flow rate of a coolant supplied to a heater core and an oil warmer after passing through the engine is minimized.

13. The thermal energy management system of claim 1,
wherein the control unit is further configured to further perform the control to secure the engine latent heat during the stay mode after arriving at the stay place, and
wherein the control to secure the engine latent heat during the stay mode includes control of a valve of an integrated thermal management system so that all a coolant is circulated only through a circulation path between the engine and a heater core and the coolant does not flow to a radiator and an oil warmer.

14. The thermal energy management system of claim 1,
wherein the control unit is further configured to further perform the control to secure the engine latent heat during the stay mode after arriving at the stay place, and
wherein the control to secure the engine latent heat during the stay mode includes control of an electric heating load of the vehicle.

15. The thermal energy management system of claim 14, wherein, as the control to secure the engine latent heat during the stay mode, the control of the electric heating load of the vehicle is control configured to operate the electric heating load at a maximum heating level or to turn on the electric heating load in response that the electric heating load is configured for only being turned on or off, during heating in a stopped state of the vehicle after arriving at the stay place.

16. The thermal energy management system of claim 1, wherein the control unit is further configured to start the control to secure the engine latent heat, in response that a remaining distance to the stay place is less than or equal to a set distance while the vehicle is driving toward the stay place.

17. A method for controlling thermal energy management system for heating in an electrified vehicle, the method comprising:
receiving, by a control unit, an input to enter a stay mode configured to allow a vehicle user to rest in the vehicle, use air conditioning, or use electrical energy of the vehicle in a parked state after arriving at a stay place, while the vehicle is driving;
entering, by the control unit, a stay preparation mode while the vehicle is driving to the stay place, in response to receiving the input to enter the stay mode,
wherein the control unit is configured to perform control to secure engine latent heat to be used during heating in the stay mode based on collected heating setting information and environmental information at the stay place, during the stay preparation mode until the vehicle arrives at the stay place.

18. The method of claim 17, further including:
determining, by the control unit, whether the heating is needed after the vehicle arrives at the stay place based on a vehicle interior temperature detected by a sensor or a target heating temperature among the heating setting information, and an ambient air temperature of the stay place, which is the environmental information at the stay place; and
performing, by the control unit, control to secure the engine latent heat upon concluding that the heating is needed.

19. The method of claim 17, further including:
determining a necessary heat load based on the heating setting information and the environmental information at the stay place;
determining a control intensity based on the determined necessary heat load and the environmental information at the stay place; and
performing the control to secure the engine latent heat depending on the determined control intensity.
